(19) United States
(12) Patent Application Publication
(10) Pub. No.: US 2002/0175502 A1
(43) Pub. Date: Nov. 28, 2002

(54) Tensioning assembly for curtain style inflatable air bag

(76) Inventors: Todd E. Tesch, Tipp City, OH (US); Jennifer M. Tobe, Tipp City, OH (US); Shawn Gregory Ryan, Dayton, OH (US)

Correspondence Address: KATHRYN A. MARRA, DELPHT TECHNOLOGIES, INC., Legal Staff, Mail Code: 480-414-420, P.O. Box 5052, Troy, MI, 48007-5052, US

(21) Appl. No.: 09/864,713

(22) Filed: May 23, 2001

(51) Int. Cl. B60R 21/22; B60R 21/16

(52) U.S. Cl. 280/730.2; 280/743.2

(57) ABSTRACT

An inflatable restraint assembly including an inflatable curtain structure deployable from a storage position adjacent the roof rail of the vehicle above the doors so as to extend downwardly over an area within the vehicle interior adjacent to an occupant to be protected. The inflatable curtain structure is operatively connected to one or more variable length tethering elements extending between the inflatable curtain structure and an anchoring structure adjacent the lateral end of the curtain structure so as to apply a generally horizontal force component along the length of the inflatable curtain structure. As the inflatable curtain structure is deployed downwardly from the storage location, the operative length of the tethering element is shortened in the horizontal direction thereby enhancing tension along the length of the inflatable curtain structure.

### TECHNICAL FIELD

The present invention relates to an inflatable restraint assembly useful within the interior of a transportation vehicle to cover a side portion of the vehicle interior adjacent to an occupant to be protected during a collision or extended roll-over event. More particularly, the invention relates to a curtain style inflatable air bag cushion assembly incorporating a tensioning subassembly activatable upon deployment of the air bag cushion to maintain the air bag cushion in a tensioned condition following deployment.

### BACKGROUND OF THE INVENTION

It is well known in motor vehicles to provide air bag cushions for protecting a vehicle occupant during a collision event wherein such air bag cushions are in fluid communication with gas generating inflators so as to inflate the cushions upon sensing predetermined vehicle conditions such as deceleration exceeding a certain level. It is further known to provide air bag systems at storage positions extending generally along the roof rail portion of the vehicle frame above the doors of the vehicle such that the inflatable restraint cushion extends downwardly in substantially curtain-like fashion between the occupant to be protected and the side portion of the vehicle adjacent to such occupant. Such coverage is intended to provide cushioning restraint for the occupant during a side impact or an extended roll-over collision event.

It is believed to be generally desirable for a curtain-like side air bag cushion to be held in a substantially tensioned condition across the surface being covered so as to provide a barrier between the occupant and the covered region. Such a condition is believed to be useful in holding the occupant within the protective frame of the vehicle during an extended roll-over event.

In the past, it has been proposed to utilize tethers of defined length attached between the lower edge of the curtain and structural pillars adjacent either end of the region covered by the air bag cushion. Such tethering arrangements are illustrated and described in U.S. Pat. No. 6,168,191 to Webber et al. the contents of which are incorporated by reference herein. In such tethering configurations, as the air bag cushion is inflated, it undergoes a natural shortening of its length as material is taken up during an increase in depth as the air bag cushion billows into an inflated condition. The tethering straps attached at either end are placed into tension as the cushion is shortened and prevent shortening from occurring beyond predefined limits.

While the past tethering techniques have been generally effective, the fixed length of the tethers have required that individual tether lengths be matched to particular inflation characteristics for a given cushion design within a particular vehicle. In addition, proper tensioning is dependent upon the substantially complete inflated deployment of the air bag cushion and the maintenance of that condition throughout the event of interest.

### SUMMARY OF THE INVENTION

This invention provides advantages and alternatives over the prior art by providing an inflatable restraint assembly including an inflatable curtain structure deployable from a storage position adjacent the roof rail of the vehicle above the doors so as to extend downwardly over an area within the vehicle interior adjacent to an occupant to be protected. The inflatable curtain structure is operatively connected to one or more variable length tethering elements extending between the inflatable curtain structure and an anchoring structure adjacent the lateral end of the curtain structure so as to apply a generally horizontal force component along the length of the inflatable curtain structure. As the inflatable curtain structure is deployed downwardly from the storage location, the operative length of the tethering element is shortened in the horizontal direction thereby enhancing tension along the length of the inflatable curtain structure.

### BRIEF DESCRIPTION OF THE DRAWINGS

The accompanying drawings which are incorporated in and which constitute a part of the specification illustrate several potentially preferred embodiments of the present invention and, together with a general description of the invention given above and the detailed description set forth below, serve to explain the principles of the invention wherein:

FIG. 1 is a cut-away view of the interior of an automotive vehicle incorporating an embodiment of the inflatable restraint assembly according to the present invention;

FIG. 2 is a view similar to FIG. 1 following activation of the inflatable restraint assembly;

FIG. 3 illustrates one embodiment of the inflatable restraint assembly prior to deployment and illustrating elements of a tensioning subassembly;

FIG. 4 is a view similar to FIG. 3 following activation of the inflatable restraint assembly;

FIG. 5 illustrates a tensioning subassembly using concentric take-up and release rolls for use in an inflatable restraint assembly according to the present invention;

FIG. 6 is a side view of a take-up and release element for use in the tensioning subassembly illustrated in FIG. 5;

FIG. 7 illustrates a pulley based tensioning sub-assembly useful in an inflatable restraint assembly according to the present invention; FIG. 8 is a view similar to FIG. 7 following activation of the inflatable restraint assembly;

FIG. 9 illustrates an arrangement for an inflatable cushion and a vertically extending portion of a tensioning sub-assembly in an inflatable restraint assembly according to the present invention;

FIG. 10 is a view similar to FIG. 9 illustrating an alternative arrangement of the air bag cushion and tensioning sub-assembly;

FIG. 11 illustrates an arrangement of an inflatable cushion and a tensioning sub-assembly in an inflatable restraint assembly wherein the inflatable cushion is supported by a sling element;

FIGS. 12-14 illustrate various arrangements for the vertical portion of a tensioning subassembly and sling element within an inflatable restraint assembly;

FIG. 15 illustrates an attachment arrangement between an inflatable air bag cushion and a tensioning subassembly;

FIG. 16 illustrates a tensioning subassembly incorporating a locking mechanism to maintain a tensioned position following deployment; and

FIGS. 17-23 illustrate various configurations for a locking mechanism for use in a tensioning subassembly.

While the invention has been illustrated and generally described above and will hereinafter be described in connection with certain potentially preferred embodiments, it is to be understood and appreciated that in no event is the invention to be limited to such illustrated and described embodiments. On the contrary, it is intended that the present invention shall extend to all alternatives and modifications as may embrace the broad principles of this invention within the true spirit and scope thereof.

### DESCRIPTION OF THE PREFERRED EMBODIMENT

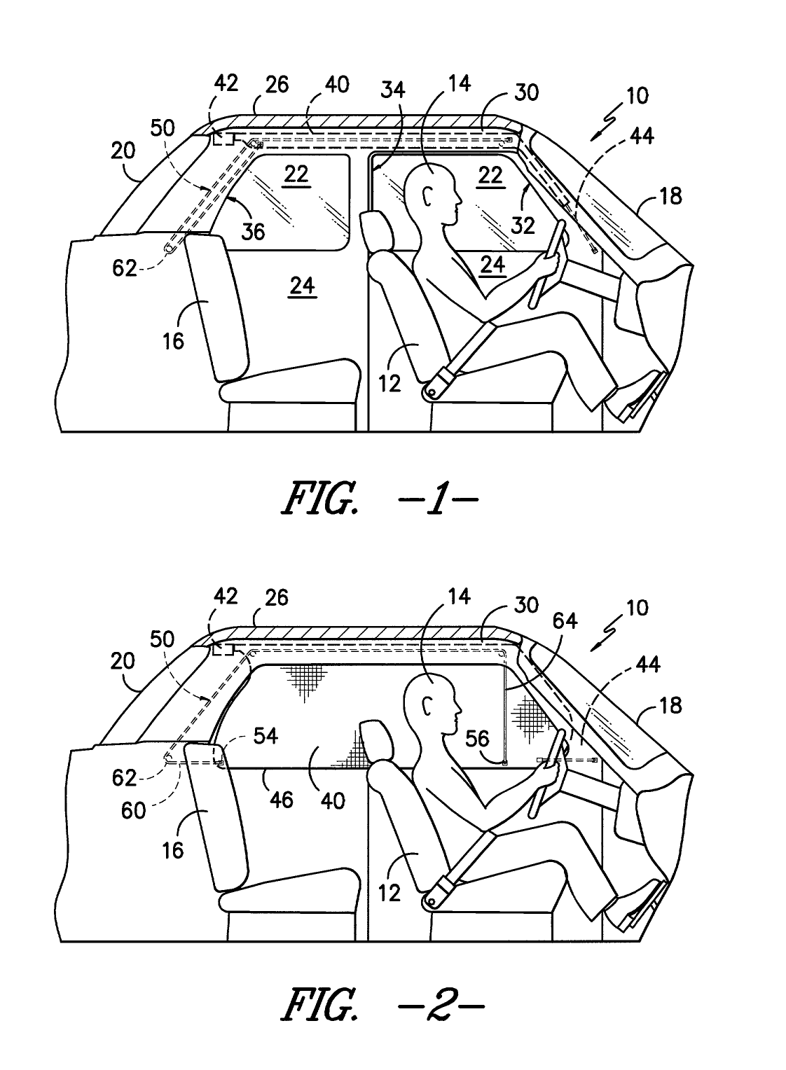

Turning now to the drawings, in FIG. 1 there is illustrated a vehicle 10. As illustrated, the vehicle 10 includes a front seat 12 which may be used to support a front seated vehicle occupant 14. The vehicle 10 may further include a rear seat 16 which may be used to support a rear occupant (not shown). While the front seat 12 and the rear seat 16 are illustrated as being located on the driver's side of the vehicle 10, it is to be appreciated that the present invention is also useful in the protection of an occupant (not shown) seated in either the front seat or the rear seat on the passenger side of the vehicle 10. Moreover, while the vehicle 10 is illustrated as incorporating two rows of seats 12, 16, it is likewise contemplated that the vehicle 10 may house only a single row of seats 12 or may likewise include three or more rows of seats if desired. In order to provide visibility to the occupants of the vehicle 10, the vehicle 10 is preferably provided with a windshield 18 and with a rear view window 20. The vehicle 10 may also be provided with one or more side windows 22 disposed within doors 24 which extend adjacent to the vehicle occupants towards a roof 26.

As will be appreciated by those of skill in the art, the vehicle 10 preferably includes a structural frame formed by an arrangement of support members including a roof rail 30 disposed intermediate the doors 24 and the roof 26. The structural frame also preferably includes a series of structural pillars 32, 34, 36 which extend generally downwardly away from the roof rail 30 in spaced relation along the side of the vehicle 10 between the windshield 18 and the rear view window 20. The structural pillar 32 which extends between the windshield 18 and the side window 22 adjacent the front seat 12 is commonly referred to as the “A” pillar. The structural pillar 34 which is disposed rearwardly of the “A” pillar and generally between the doors 24 is commonly referred to as the “B” pillar. The structural pillar 36 disposed still further rearward along the side of the vehicle 10 adjacent to the rear seat 16 is commonly referred to as the “C” pillar. Of course, it will be appreciated that a greater or lesser number of pillars may be utilized depending upon the configuration of the vehicle 10. As will be appreciated, each of the structural pillars 32, 34, 36 is preferably covered by a trim piece of plastic material or the like which extends in elongate fashion away from the roof rail 30. The roof rail 30 is likewise preferably covered by an appropriate trim piece or headlining material in a manner well known to those of skill in the art.

As illustrated through simultaneous reference to FIGS. 1-4, it is contemplated that an air bag cushion in the form of an inflatable curtain structure 40 may be stored in rolled or folded fashion along the roof rail 30 in a region above the doors 24 adjacent to the occupant 14 to be protected. According to one potentially preferred practice, the inflatable curtain structure 40 may be secured in place to the roof rail 30 by connective elements such as screws or the like extending through attachment openings 41 and into the roof rail 30 along the upper edge 43. Of course, other attachment mechanisms may also be utilized if desired. It is also contemplated that portions of the inflatable curtain structure 40 may also be stored along segments of the “A” pillar 32 and/or “C” pillar 36 if desired thereby assuming a curved storage profile. The inflatable curtain structure 40 is preferably in fluid communication with a gas discharging inflator 42 as will be well known to those of skill in the art such that gas may be discharged from the inflator 42 and into the inflatable curtain structure 40 so as to effect generally downward deployment of the inflatable curtain structure 40 adjacent to the occupant 14 upon the occurrence of predetermined vehicle conditions such as deceleration and/or axial tilt exceeding certain levels as measure by appropriate sensors (not shown).

According to the illustrated embodiment, the inflatable curtain structure 40 is attached at one end to a fixed length tethering element 44 which is secured in fixed relation along the “A” pillar 32 so as to extend between the “A” pillar 32 and a position near one end of the inflatable curtain structure 40. As shown, the point of attachment to the inflatable curtain structure 40 is preferably near the lower edge 46 to promote tensioning in that region. The fixed length tethering element 44 is preferably formed of a substantially inelastic material such as a strap or cord of textile material or the like.

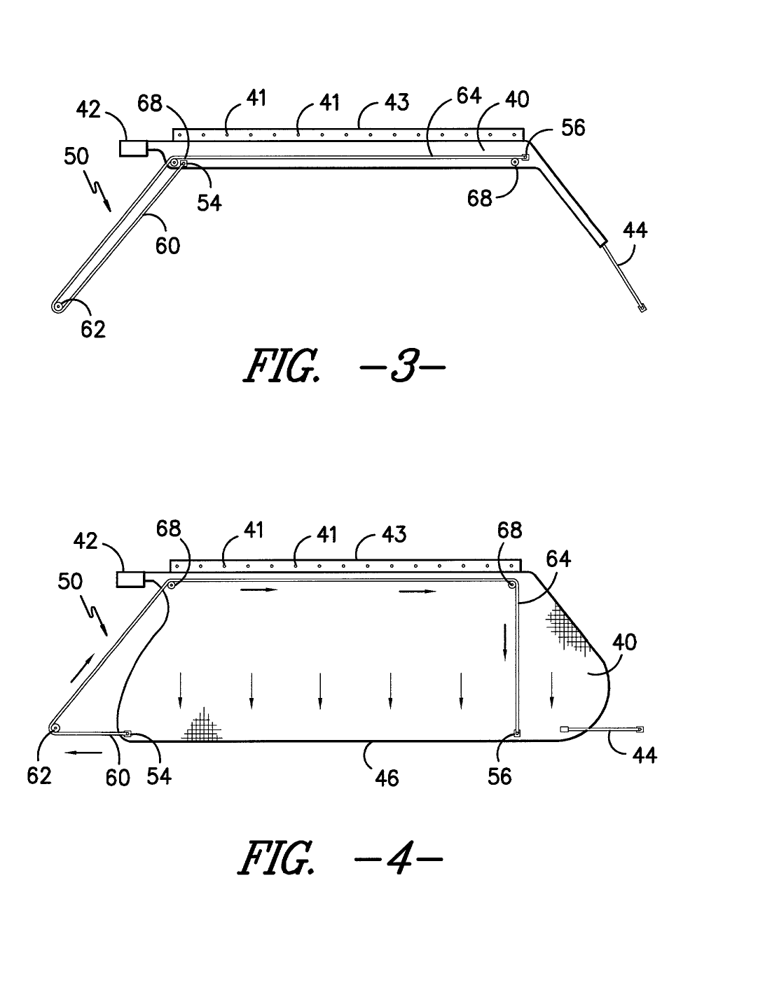

As best illustrated in FIGS. 3 and 4, the inflatable curtain structure 40 is also operatively connected to a dynamic tensioning subassembly 50 to apply tension across the inflatable curtain structure 40 in substantially opposing relation to the fixed length tethering element 44. As shown, the dynamic tensioning subassembly 50 is preferably operatively connected to the inflatable curtain structure 40 at a first attachment position 54 adjacent one lateral edge of the curtain structure 40 and at a second attachment position 56 inboard of the first attachment position 54. Preferably, the first attachment position 54 and the second attachment position 56 are generally in alignment with the position of attachment by the fixed length tethering element 44. Thus, the second attachment position 56 is preferably disposed at a position between the first attachment position 54 and the fixed length tethering element 44 at the same relative height away from the bottom edge 46 of the inflatable curtain structure 40 so as to provide a line of tensioning points adjacent the bottom edge 46. Of course, additional tension inducing elements such as described in U.S. Pat. No. 6,168,191 to Webber et al. may also be incorporated if desired. In addition, it is contemplated that the fixed length tethering element 44 may be eliminated if desired.

According to the illustrated embodiment, a first segment of tethering material 60 preferably extends away from the first end 54 and toward a support element 62 housed at the “C” pillar or such other structural member as may be suitable adjacent the region covered by the inflatable curtain structure 40. According to the illustrated and potentially preferred practice, the direction support element 62 is positioned at a height corresponding substantially to the position of the lower edge 46 of the inflatable curtain structure 40 upon full deployment. The dynamic tensioning subassembly 50 further preferably includes a second segment of tethering material 64 which extends along a travel path between the second attachment position 56 and the support element 62. As shown, the second segment of tethering material 64 is preferably supported along its travel path by one or more guide elements 68 along the roof rail 30. The guide elements 68 are preferably low friction studs or eyelets to promote sliding by the second segment of tethering material 64. While the embodiment of the invention illustrated in FIGS. 3 and 4 utilizes two guide elements 68, it is also contemplated that a single guide element may be utilized in the event that tension is not to be applied over a substantial length (FIG. 5).

It is contemplated that the first segment of tethering material 60 may be either attached to the second segment of tethering material 64 or may be separate. In the event that the segments of the tethering material are separate, it is contemplated that the support element 62 preferably provides cooperating take-up and extension functions to facilitate control of the tensioning. However, regardless of the actual construction utilized in the dynamic tensioning subassembly 50, the tensioning function is carried out in substantially the same manner. In this regard, as inflation gas is discharged by the inflator 42 into the inflatable curtain structure 40, the inflatable curtain structure 40 is caused to expand away from its initial storage position and to deploy in a generally downward direction adjacent to the occupant 14 to be protected. As the inflatable curtain structure 40 is deployed, the second segment of tethering material 64 is pulled away from the support element 62 so as to cause a lengthening of the total distance between the support element 62 and the second attachment position 56. Simultaneous with the increase in length between the second attachment position 56 and the support element 62, the distance between the first attachment position 54 and the support element 62 is shortened as available material is fed into the lengthened region. Since the first segment of tethering material 60 is being shortened in order to increase the length of the second segment of tethering material 64, a state of tension is established and maintained between the first attachment position 54 and the second attachment position 56 during deployment. In the embodiment illustrated in FIGS. 3 and 4 wherein the first and second segments of tethering material are connected, a 1 to 1 ratio is established between the increase in length of the second segment of tethering material and the decrease in length of the first segment of tethering material.

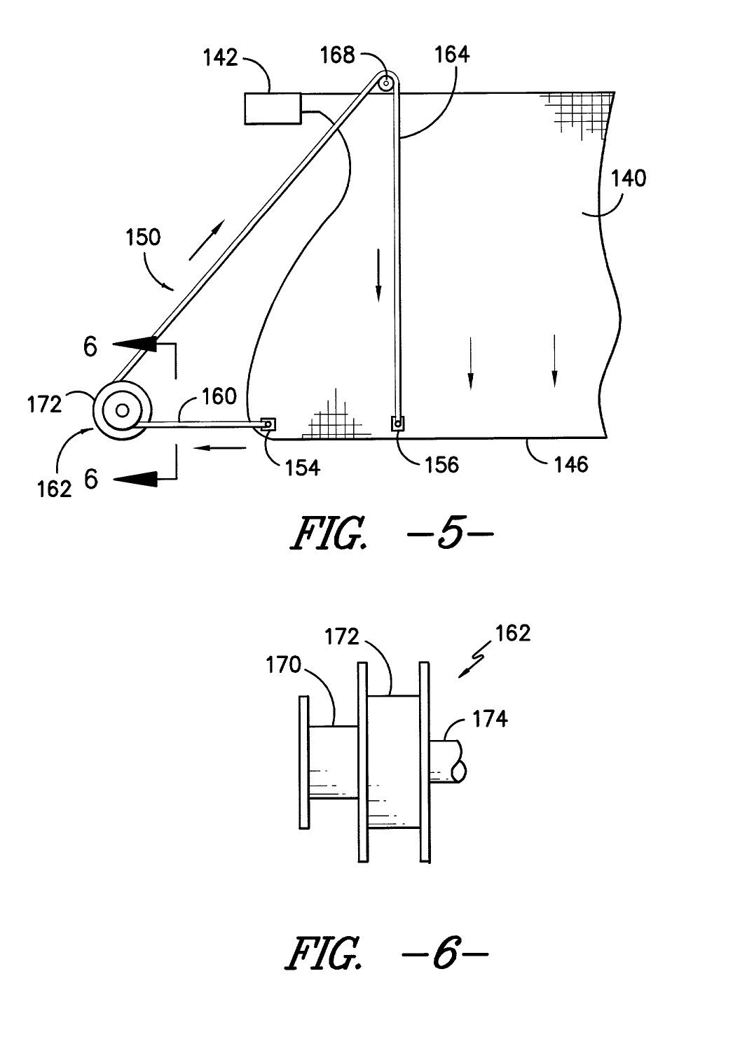

As will be appreciated, the present invention may be the subject of any number of design choices to achieve performance characteristics as may be desired. By way of example only, FIG. 5 illustrates an embodiment of the invention having a description similar to that in FIGS. 1-4 and in which similar components are denoted by similar reference numerals increased by 100. As shown, in this embodiment the dynamic tensioning subassembly 150 is arranged so as to provide tensioning generally adjacent one end of the inflatable curtain structure 140. Accordingly, the first and second attachment positions 154, 156 are arranged in relative close proximity to one another adjacent the end of the inflatable curtain structure 140. Due to this localized tensioning, only a single guide element 168 is utilized. FIG. 5 also illustrates the use of a first segment of tethering material 160 which is separate from the second segment of tethering material 164. In the illustrated embodiment, the support element 162 comprises an assembly of concentric winding rolls as best seen in FIG. 6. In such an arrangement, the first segment of tethering material 160 extends between the first attachment position 154 and an interior take-up roll 170. The second segment of tethering material 164 extends between the second attachment position 156 and a larger diameter release roll 172. The interior take-up roll 170 and release roll 172 are preferably arranged along a central hub 174 for common angular rotation. In operation, as the inflatable curtain structure 140 is deployed downwardly, the second segment of tethering material 164 is lengthened by pulling additional material away from the release roll 172. This pulling action causes the release roll 172 and the attached interior take-up roll 170 to rotate in the same direction and through the same angle. This action causes the first segment of tethering material 160 to wind around the interior take-up roll 170 thereby causing its length to shorten. As will be appreciated, the first segment of tethering material 160 may be shortened at various ratios relative to the increase in length in the second segment of tethering material 164 due to the differences in diameter between the interior take-up roll 170 and the release roll 172. Such an arrangement may thereby provide an additional degree of control over tensioning.

FIGS. 7 and 8 show yet another alternative embodiment of the invention wherein similar components to those previously described in relation to FIGS. 1-4 are denoted by like reference numerals increased by 200. As shown, in this embodiment the first segment of tethering material 260 is of a substantially fixed length attached to a first pulley wheel 280. The first pulley wheel 280 is operatively connected to a second pulley wheel 282 carrying the second segment of tethering material 264. As illustrated, upon deployment of the inflatable curtain structure 240, the distance between the first pulley wheel 280 and the second pulley wheel 282 is contracted until deployment is substantially complete. Due to the fixed length of the first segment of tethering material 260, no corresponding shortening of the first segment of the tethering material 260 is required.

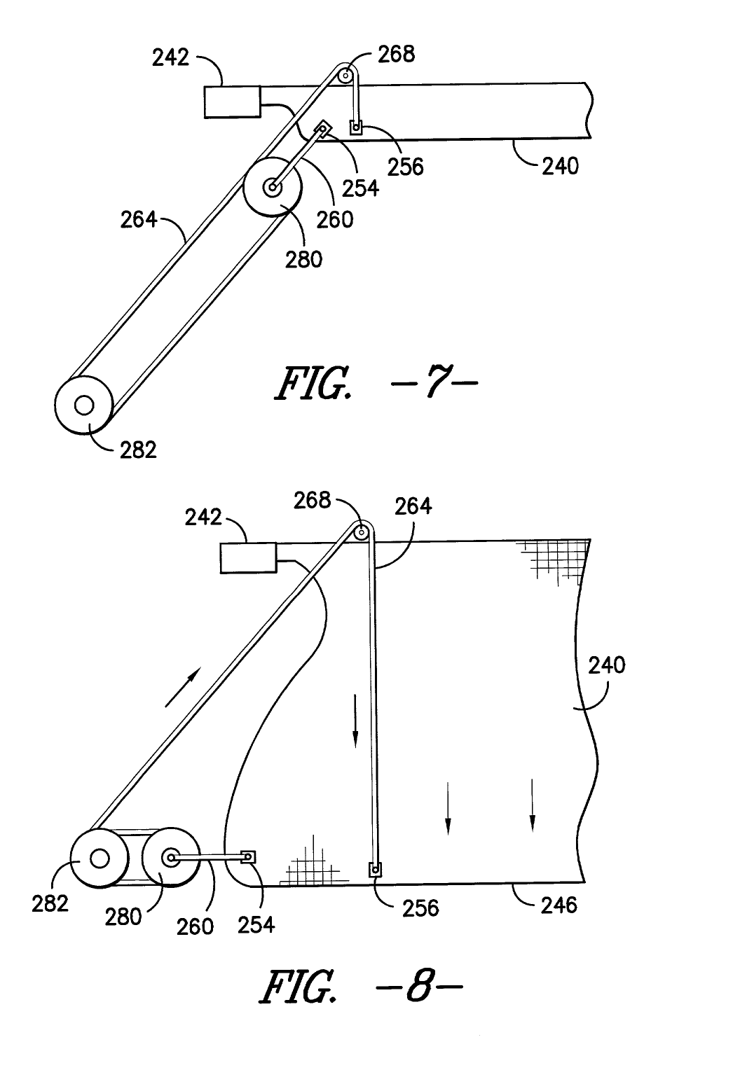

In FIGS. 9 and 10 various arrangements are illustrated for the direct connection between the inflatable curtain structure 40 and the second segment of tethering material 64. As shown in FIG. 9, the second segment of tethering material 64 extends in a substantially straight vertical path away from a position adjacent the roof rail 30 and towards the second attachment position 56 along the impact face of the inflatable curtain structure 40. In FIG. 10 an alternative attachment arrangement is illustrated wherein elements corresponding to those illustrated to those in FIG. 9 are denoted by like reference numerals with a prime. As shown, in this embodiment the second segment of tethering material 64′ extends in a wrap-around relationship to the inflatable curtain structure 40′ for attachment on the opposite side at the second attachment position 56′. As will be appreciated, upon deployment of the inflatable curtain structure 40′, the length of the second segment of tethering material 64′ is increased substantially in comparison to the change in length experienced by the second segment of tethering material 64 in the arrangement illustrated in FIG. 9. Of course, intermediate levels of lengthening may be achieved by adjustment of the second attachment position 56′ to some intermediate position. Thus, by adjusting the position of the second attachment position 56, the change in length experienced by the second segment of tethering material may be either increased or decreased causing a corresponding increase or decrease in the degree to which the first segment of tethering material is shortened. That is, the more the second segment of tethering material 64 is lengthened, the shorter the first segment of tethering material 60 becomes. Thus, the position of the second attachment position 56 may be used to control tensioning characteristics.

FIG. 11 illustrates yet another embodiment of the present invention having a description generally similar to that of FIGS. 1-4 and in which similar components are denoted by similar reference numerals increased by 300. As shown, in the embodiment of FIG. 11, the second segment of tethering material 364 is connected to a non-inflating sling 384 which in turn is connected to the inflatable curtain structure 340 over an extended length. Such an arrangement may facilitate the distribution of force along the length of the inflatable curtain structure 40.

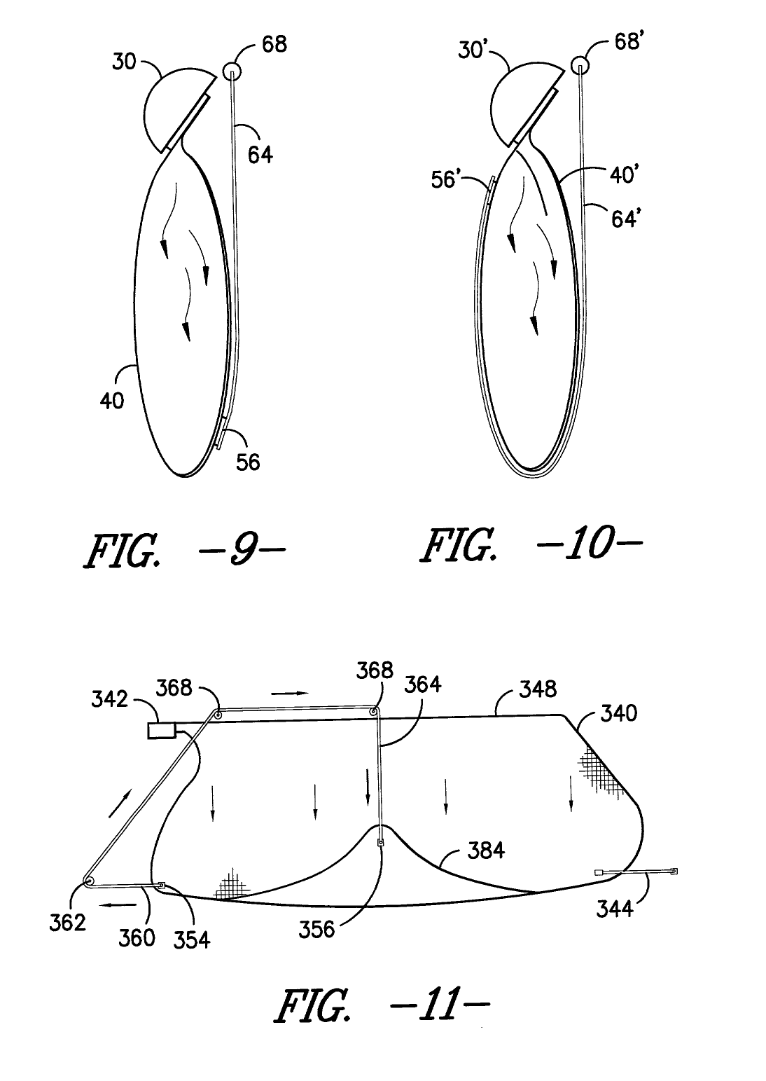

FIGS. 12-14 illustrate various arrangements for attachment of the second segment of tethering material 364 to the non-inflating sling 384. FIG. 12 illustrates a first attachment relationship in which components similar to those in FIG. 11 are denoted by similar numerals with a prime. As shown, in this embodiment the second segment of tethering material 364′ is attached to the non-inflating sling 384′ which in turn is attached to the impact face of the inflatable curtain structure 340′. The embodiment illustrated in FIG. 13 is similar in all respects to the embodiment illustrated in FIG. 12 but wherein the non-inflating sling 384″ extends in a cradling wrap-around relation to the inflatable curtain structure 340″. FIG. 14 illustrates an embodiment similar in all respects to FIG. 13 but wherein the second segment of tethering material 364′″ is of a split construction so as to provide a full cradling relationship with respect to the inflatable curtain structure 340′″.

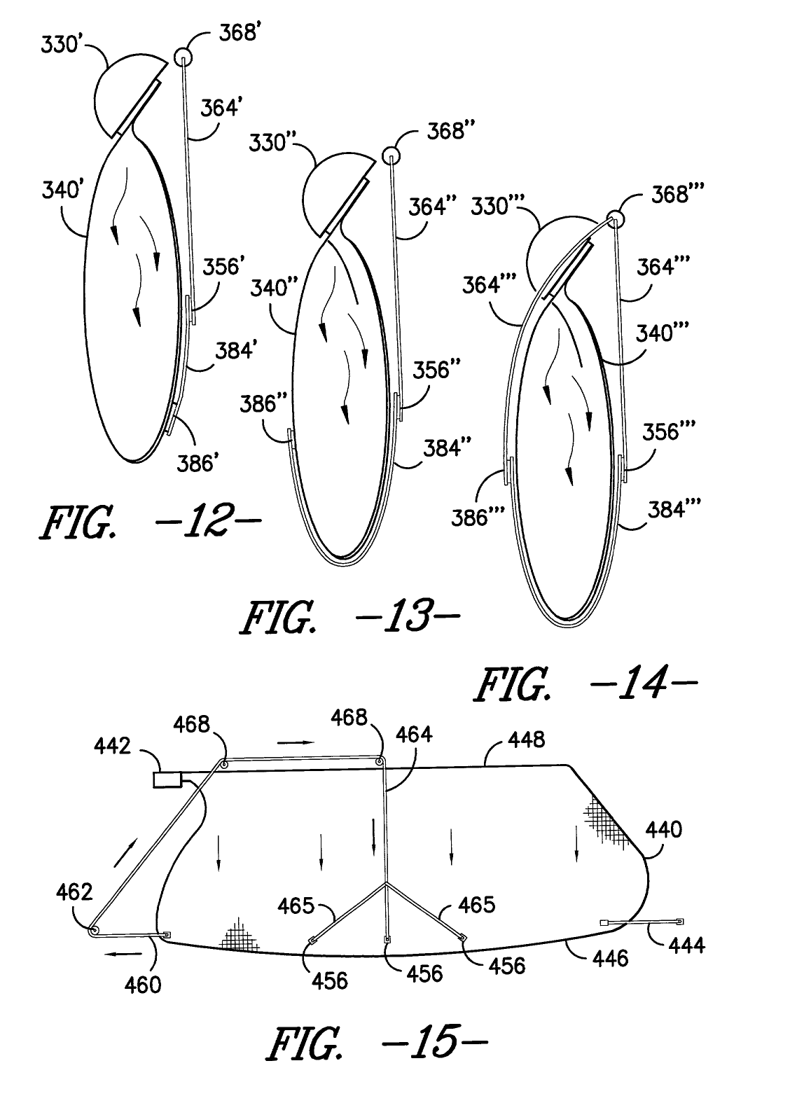

FIG. 15 illustrates still another embodiment of the invention having a description and operation similar to that of FIGS. 1-4 and in which similar components are denoted by similar reference numerals increased by 400. As shown, in this embodiment the second segment of tethering material 464 is of a split construction terminating in a plurality of legs 465 extending to positions along the length of the inflatable curtain structure 440. Of course, it is contemplated that such a split construction may be utilized in combination with any of the previously described embodiments if desired.

FIG. 16 illustrates yet a further potential embodiment of an inflatable restraint assembly in which similar components to those illustrated and described in relation to FIGS. 1-4 are denoted by like reference numerals increased by 500. As illustrated, in this embodiment a locking element 590 is disposed along the travel path of the tethering material so as to prevent retraction of the first segment of tethering material 560 back to a nontensioned condition after deployment has taken place. It is contemplated that the locking element 590 may take on any number of different configurations. The potentially preferred position for such locking element 590 is along the “C” pillar or such other structural frame element as may be immediately adjacent the lateral side of the region covered by the inflatable curtain structure 540.

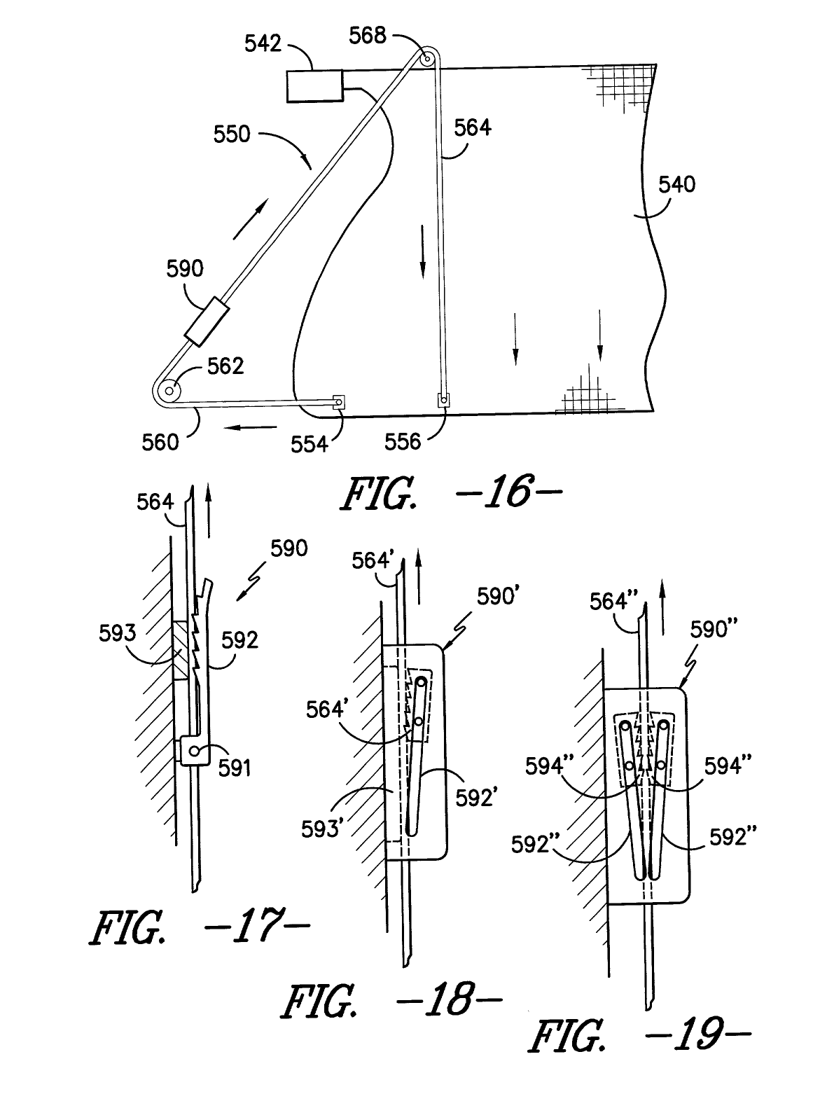

According to a first embodiment, the locking element 590 may include a spring loaded pivot arm 592 which permits hinges towards and away from a grasping surface 593. Angled teeth elements 594 are arranged along the pivot arm 592 in opposing relation to the grasping surface 593 so as to permit the free movement of the tethering material in a direction towards the guide element 568 (FIG. 16) while preventing movement in the reverse direction. An alternative embodiment of a locking structure is illustrated in FIG. 18 in which a floating arm element 592′ is utilized to permit passage of the tethering material in the identified direction but which locks down if passage in the reverse direction is attempted. In this embodiment, the floating arm element 592′ incorporates an angled sliding shoulder surface 594′ below the gripping teeth to maintain a distance between the tethering material and the gripping teeth when movement is in the desired direction. FIG. 19 illustrates still a further alternative embodiment similar to FIG. 18 but utilizing two floating arms 592″ each including an angled sliding shoulder surface at a position below directional teeth elements.

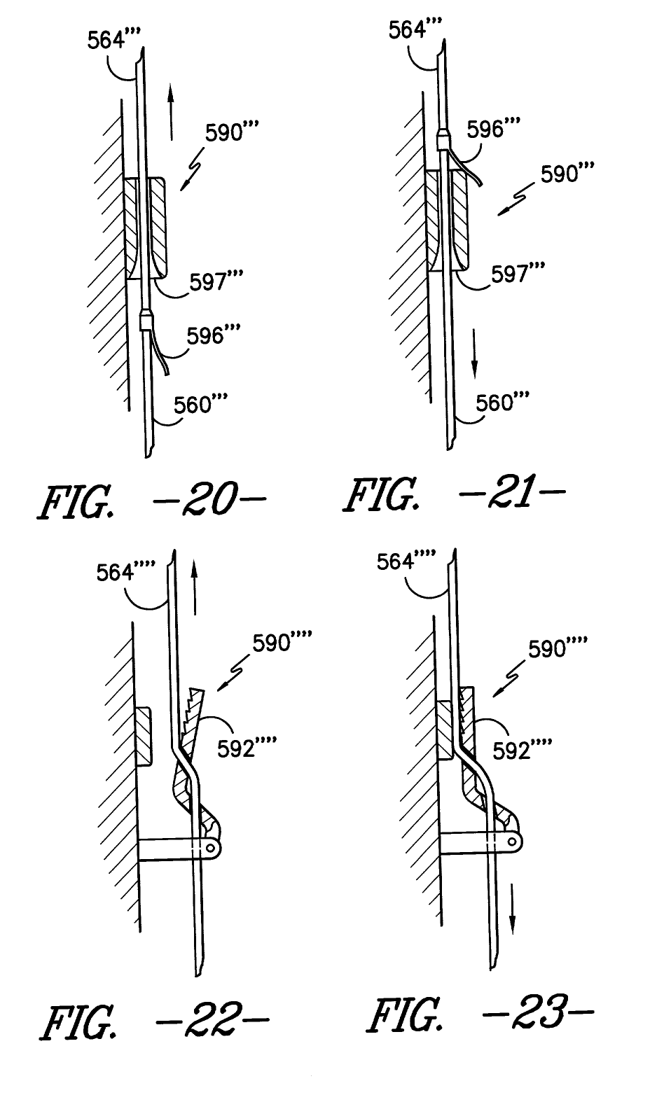

FIGS. 20 and 21 illustrate yet another embodiment of a locking element 590′″. As shown in this embodiment a locking relation is established by a stand off element 596′″ such as a piece of fabric or the like which is capable of passing through a gradually constricting orifice 597′″ but which is blocked against return passage as shown in FIG. 21.

FIGS. 22 and 23 illustrate yet another embodiment of a locking element 590″″ wherein tethering material passes through an opening in a locking arm 592″″ to bias the locking arm 592″″ to an open position during movement of the tethering material in the desired direction (FIG. 22). The locking arm 592″″ is biased to a closed position upon application of force in the opposite direction (FIG. 23) thereby locking the tethering material in place.

It is to be understood that while the present invention has been illustrated and described in relation to certain potentially preferred embodiments, constructions, and procedures for explanatory purposes such embodiments, constructions and procedures are intended to be illustrative only and the present invention is in no event to be limited thereto. In particular, it is to be understood that while the dynamic tensioning subassembly has been illustrated in disposition along the “C” pillar of the vehicle 10, it may likewise be disposed along the “B” pillar or the “A” pillar or any other support surface as may be convenient and available. In addition, while only a single dynamic tensioning subassembly has been illustrated adjacent a single end of an inflatable curtain structure, it is likewise contemplated that two or more such dynamic tensioning subassemblies may be utilized if desired. Accordingly, it is to be understood that the present invention is intended to extend to all modifications and variations as may incorporate the broad aspects of the invention within the full spirit and scope of the appended claims and all equivalents thereto.

1. An inflatable restraint assembly for use in protecting an occupant in a transportation vehicle, the inflatable restraint assembly comprising:
an inflatable curtain structure deployable from a storage position downwardly over a side portion of the vehicle interior adjacent to the occupant so as to extend across at least a portion of a region between a first structural pillar and a second structural pillar rearward of the first structural pillar; and
a tensioning subassembly comprising, a first segment of tethering material operatively connected to the inflatable curtain structure at a first position of attachment along the inflatable curtain structure and a second segment of tethering material operatively connected to the inflatable curtain structure at a second position of attachment along the inflatable curtain structure, the second segment of tethering material having an initial operative length prior to deployment of the inflatable curtain structure and wherein the second segment of tethering material extends along a travel path between a support element and the second position of attachment, wherein upon deployment of the inflatable curtain structure the operative length of the second segment of tethering material is increased and the first segment of tethering material is concurrently pulled towards the support element such that the first segment of tethering material is placed into tension and applies a tensioning force having a substantially horizontal component to the inflatable curtain structure.

2. An inflatable restraint assembly as recited in claim 1, wherein the first and second segments of tethering material are portions of a unitary length of tethering material.

3. An inflatable restraint assembly as recited in claim 1, wherein the first and second segments of tethering material are separate from one another.

4. An inflatable restraint assembly as recited in claim 1, wherein the first and second segments of tethering material are substantially inelastic in character.

5. An inflatable restraint assembly as recited in claim 1, wherein the tensioning subassembly further comprises a directional locking element preventing an increase in the operative length of the first segment of tethering material following deployment.

6. An inflatable restraint assembly as recited in claim 1, wherein the inflatable restraint assembly further comprises a fixed length tether extending between the inflatable curtain structure and an anchoring position in substantially opposing relation to the first segment of tethering material in the tensioning subassembly such that the inflatable curtain structure is held in tension between the fixed length tether and the first segment of tethering material in the tensioning subassembly.

7. An inflatable restraint assembly for use in protecting an occupant in a transportation vehicle, the inflatable restraint assembly comprising:
an inflatable curtain structure deployable from a storage position downwardly over a side portion of the vehicle interior adjacent to the occupant so as to extend across at least a portion of a region between a first structural pillar and a second structural pillar rearward of the first structural pillar; and
a tensioning subassembly comprising, a first segment of tethering material operatively connected to the inflatable curtain structure and a second segment of tethering material operatively connected to the inflatable curtain structure, the first segment of tethering material having an initial operative length prior to deployment of the inflatable curtain structure and extending between a first position of attachment along the inflatable curtain structure and a support element disposed at one of the structural pillars, the second segment of tethering material having an initial operative length prior to deployment of the inflatable curtain structure and extending along a travel path between the support element and a second position of attachment inboard of the first position of attachment, at least one guide element supporting the second segment of tethering material along said travel path at a position above the support element such that upon deployment of the inflatable curtain structure a portion of the second segment of tethering material is pulled downwardly in a generally vertical direction away from said at least one guide element whereby the operative length of the second segment of tethering material is increased, and the first segment of tethering material is concurrently pulled towards the support element such that the first segment of tethering material is placed into a state of tension and applies a tensioning force including a substantially horizontal component to the inflatable curtain structure.

8. An inflatable restraint assembly as recited in claim 7, wherein the first and second segments of tethering material are portions of a unitary length of tethering material.

9. An inflatable restraint assembly as recited in claim 7, wherein the first and second segments of tethering material are separate from one another.

10. An inflatable restraint assembly as recited in claim 9, wherein the support element comprises an arrangement of substantially concentric roll structures arranged on a common rotational axis including a first roll structure for taking up a portion of the first segment of tethering material so as to shorten the operative length of the first segment of tethering material during deployment of the inflatable curtain structure and a second roll segment for discharging a portion of the second segment of tethering material so as to lengthen the operative length of the second segment of tethering material during deployment of the inflatable curtain structure.

11. An inflatable restraint assembly as recited in claim 10, wherein the first roll segment and the second roll segment are of differing diameters.

12. An inflatable restraint assembly as recited in claim 11, wherein the first roll segment is of a smaller diameter than the second roll segment.

13. An inflatable restraint assembly as recited in claim 7, wherein the first and second segments of tethering material are substantially inelastic in character.

14. An inflatable restraint assembly as recited in claim 7, wherein the tensioning subassembly further comprises a directional locking element preventing an increase in the operative length of the first segment of tethering material following deployment.

15. An inflatable restraint assembly as recited in claim 14, wherein the directional locking element comprises an assembly including an arrangement of teeth arranged along a supporting arm element disposed adjacent to at least one of the first and second segments of tethering material wherein said teeth are angled to permit movement of the tethering material in one direction but which prevent movement in the opposite direction.

16. An inflatable restraint assembly as recited in claim 15, wherein the supporting arm element is biased away from the tethering material when the tethering material is moving in a direction corresponding to an increase in the operative length of the second segment of tethering material and wherein the supporting arm element is biased towards the tethering material when the tethering material moves in a reverse direction corresponding to an increase in the operative length of the first segment of tethering material.

17. An inflatable restraint assembly as recited in claim 14, wherein the directional locking element comprises an assembly including a passageway for passage of a standoff element disposed along the length of the tethering material when the tethering material is moving in a first direction corresponding to an increase in the operative length of the second segment of tethering material and wherein the passageway blocks return passage of the standoff element when the tethering material moves in a reverse direction corresponding to an increase in the operative length of the first segment of tethering material.

18. An inflatable restraint assembly as recited in claim 7, wherein the inflatable restraint assembly further comprises a fixed length tether extending between the inflatable curtain structure and an anchoring position at the other of structural pillars in substantially opposing relation to the first segment of tethering material in the tensioning subassembly such that upon deployment the inflatable curtain structure is held in tension between the fixed length tether and the first segment of tethering material in the tensioning subassembly.

19. An inflatable restraint assembly as recited in claim 7, wherein the second segment of tethering material extends in cradling relation beneath a lower edge of the inflatable curtain structure.

20. An inflatable restraint assembly as recited in claim 7, wherein the second segment of tethering material is operatively connected to the inflatable curtain structure by means of a sling element.

21. An inflatable restraint assembly as recited in claim 20, wherein the sling element extends in cradling relation beneath a lower edge of the inflatable curtain structure along a portion of the length of the inflatable curtain structure.

22. An inflatable restraint assembly as recited in claim 7, wherein the second segment of tethering material is operatively connected to the inflatable curtain structure at a plurality of attachment points disposed along a portion of the length of the inflatable curtain structure.

23. An inflatable restraint assembly for use in protecting an occupant in a transportation vehicle, the inflatable restraint assembly comprising:
an inflatable curtain structure deployable from a storage position downwardly over a side portion of the vehicle interior adjacent to the occupant so as to extend across at least a portion of a region between a first structural pillar and a second structural pillar rearward of the first structural pillar;
a substantially fixed length tether extending between the inflatable curtain structure and the first structural pillar; and
a tensioning subassembly comprising, a first segment of tethering material operatively connected to the inflatable curtain structure and a second segment of tethering material operatively connected to the inflatable curtain structure, the first and second segments of tethering material each being of substantially inelastic character, the first segment of tethering material having an initial operative length prior to deployment of the inflatable curtain structure and extending between a first position of attachment along the inflatable curtain structure and a support element disposed at the second structural pillar, the second segment of tethering material having an initial operative length prior to deployment of the inflatable curtain structure and extending along a travel path between the support element and a second position of attachment inboard of the first position of attachment, at least one guide element supporting the second segment of tethering material along said travel path at a position above the support element such that upon deployment of the inflatable curtain structure a portion of the second segment of tethering material is pulled downwardly in a generally vertical direction away from said at least one guide element whereby the operative length of the second segment of tethering material is increased, and the first segment of tethering material is concurrently pulled towards the second structural pillar such that the first segment of tethering material is placed into a state of tension and applies a tensioning force including a substantially horizontal component to the inflatable curtain structure, whereby the inflatable curtain structure is held in tension in a region between the first structural pillar and the second structural pillar.
